(19) United States
(12) Patent Application Publication
(10) Pub. No.: US 2002/0067426 A1
(43) Pub. Date: Jun. 6, 2002

(54) Electronic camera having a phoelectric sensor device

(76) Inventors: Hideki Nagata, Osaka (JP); Hiromu Mukai, Osaka (JP); Tetsuo Kohno, Osaka (JP); Hiroyuki Matsumoto, Wakayama-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/013,391

(22) Filed: Dec. 13, 2001

Related U.S. Application Data
(62) Division of application No. 09/058,360, filed on Apr. 10, 1998, now abandoned.

(30) Foreign Application Priority Data
Jan. 20, 1998 (JP) P10-008955
Apr. 10, 1997 (JP) P9-092594
Apr. 10, 1997 (JP) P9-092595

(51) Int. Cl. H04N 5/225

(52) U.S. Cl. 348/373; 348/376

(57) ABSTRACT

An electronic camera having a photoelectric sensor device is structured such that a rotational shaft of an imaging unit is horizontal to an object to be photographed. Further, the imaging unit contains a photography lens and a CCD (charge-coupled device) which are aligned horizontally to the object due to a structure that a reflection mirror deflects a light flux from the object, and then the light flux enters vertically into the photographing lens and the CCD. This composition allows a camera body to be downsized, and the photographing direction to be changed with fixing the camera body.

### BACKGROUND OF THE INVENTION

This invention relates generally to an electronic camera in which a photoelectric sensor device is used as an imaging device, and in particular to an electronic camera wherein photographing direction is changed Over with fixing a camera body. Further, the invention relates to an electronic camera having a structure that a reflection mirror is located in front of a photographing lens.

Conventionally, there has been provided an electronic camera wherein the photographing direction is changed over by rotating an entire imaging unit with a photographic optical system and a CCD (charge-coupled device) on the camera body. In some sort of such an electronic camera wherein the imaging unit is rotated along a vertical plane including an optical axis thereof, it is possible to photograph an object behind of the camera by turning the imaging unit 180 degrees. Moreover, there has also been known an electronic camera wherein an imaging unit built in a disk shaped part is rotated along a horizontal plane around a central axis of the disk shaped part, by which, the photographing direction is changed over (e.g., refer to Japanese Patent Laid-Open Publication No. 1-106581).

However, as to the former electronic camera, in order to photograph the object behind of the camera, it is needed to detect the rotated position of the imaging unit, and turn the displayed monitor image upside down. On the other hand, as to the latter electronic camera, the camera body is thicker in the back-and-forth direction than in the up-and-down direction, which makes it difficult for a photographer to hold the camera body in the photographing operation, and besides, impossible to use a monitor as an eye level finder.

Further, as to the electronic camera whose camera body is thinnest in the photography direction, it is needed a predetermined distance or more between the photographic optical system and the photoelectric sensor device, which causes a restriction in downsizing the camera body in the back-and-forth direction. Accordingly, there has been provided an electronic camera wherein a reflection mirror for deflecting a light flux from the object is located in front of the photographic optical system (e.g., refer to Japanese Patent Laid-Open Publication No. 55-631, or No. 3-227181). The construction of this sort makes it possible to photograph without the imaging unit facing toward the object, and to arrange the photographic optical system and the photoelectric sensor device vertically to the photographing direction. Therefore, these features may seem to contribute to downsizing the camera body.

However, in the above-mentioned electronic camera, the large-sized reflection mirror changes its position inside the camera body, so the entire camera body is consequently upsized. Besides, the reflection mirror does not rotate around an optical axis, so a complicated optical system is required for photographing all the surroundings of the camera.

### SUMMARY OF THE INVENTION

The present invention is made to solve the above-mentioned problems. One object of the invention is to provide an electronic camera which allows the photographer to easily hold the camera body and see the finder in the photographing operation due to the structure that the camera body is comparatively downsized, and besides, to arbitrarily change the photographing direction with fixing the camera body.

Further, another object of the present invention is to provide an electronic camera in which the reflection mirror for deflecting the light flux into the photographic optical system is folded in the camera body in a non-photographing state, thereby the freedom of the arrangement in the imaging unit can be efficiently exploited, and besides, the camera body can be downsized in the non-photographing state.

In order to accomplish the above-mentioned objects, according to one aspect of the present invention, an electronic camera comprises an imaging unit which includes a photographic optical system for projecting an image of an object to be photographed, and an imaging device for converting the image projected by the photographic optical system into an electrical signal; and, a camera body which rotatably holds the imaging unit, wherein the camera body is thinnest in a back-and-forth direction; and, wherein an imaging unit has a rotational shaft vertical to an optical axis of the photographic optical system, and rotates in a horizontal direction, and the photographing direction is changeable in both directions of right and left.

According to another aspect of the present invention, an electronic camera comprises an imaging unit which includes a photographic optical system for projecting an image of an object to be photographed, and an imaging device for converting the image projected by the photographic optical system into an electrical signal; and, a camera body which rotatably holds the imaging unit, wherein the camera body is thinnest in a back-and-forth direction; wherein the photographic optical system and the imaging device are arranged in a nearly vertical direction; and, wherein the photographic optical system is equipped in an object side thereof with a reflection mirror which deflects a light flux into the photographic optical system and is folded when the camera is not in use.

According to further aspect of the present invention, an electronic camera comprises an imaging unit which includes a photographic optical system for projecting an image of an object to be photographed, and an imaging device for converting the image projected by the photographic optical system into an electrical signal; and, a camera body which rotatably holds the imaging unit, wherein the photographic optical system and the imaging device are arranged in a nearly vertical direction; and, wherein the photographic optical system has in an object side thereof a reflection mirror which deflects a light flux into the photographic optical system, and is popped up from the camera body and rotatable around an optical axis, so that all the objects around the camera are capable of being photographed by rotating the reflection mirror.

### BRIEF DESCRIPTION OF THE DRAWINGS

FIGS. 1(a) and 1(b) are perspective views showing a front side of an electronic camera according to the first embodiment of the present invention in a non-photographing state and a photographing state respectively,

FIGS. 1(c) and 1(d) are perspective views showing a back side of the electronic camera in a state that a finder-door is closed in the non-photographing state, and a state that the finder-door is opened in the photographing state,

FIG. 2 is an exploded perspective view showing an imaging unit of the electronic camera,

FIG. 3 is a block diagram showing a control circuit of the electronic camera,

FIGS. 4(a), 4(b), 4(c) and 4(d) are plan views showing usage patterns of the electronic camera in the photographing state according to the first embodiment,

FIGS. 5(a) and 5(b) are plan views showing usage patterns of the electronic camera in the photographing state according to the first embodiment when the finder-door is opened,

FIGS. 6(a), 6(b), 6(c) and 6(d) are plan views showing patterns of the same in a non-photographing state according to the first embodiment,

FIGS. 7(a) and 7(b) are perspective views showing a front side of an electronic camera according to the second embodiment of the present invention in a non-photographing state and a photographing state respectively,

FIG. 7(c) is a perspective view showing a back side of the camera in a photographing state,

FIG. 8 is an exploded perspective view showing an imaging unit of the camera,

FIGS. 9(a) and 9(b) are perspective views showing a front side of a camera according to the third embodiment of the present invention in a non-photographing state and a back side of the same in a photographing state respectively,

FIG. 10 is an exploded perspective view showing an imaging unit of the camera,

FIG. 11 is a longitudinal sectional view showing a body of the imaging unit,

FIGS. 12(a) and 12(b) are cross sectional views respectively showing an upper block and a lower block of a click block for positioning the body of the imaging unit,

FIG. 13 is a block diagram showing a control circuit of the camera,

FIG. 14(a) is a perspective view of a camera in a photographing state according to the fourth embodiment of the present invention,

FIGS. 14(b) and 14(c) are views showing right sides of the electronic camera respectively in a non-photographing state and a photographing state,

FIG. 15 is a block diagram of a control circuit in the electronic camera,

FIGS. 16(a) and 16(b) are perspective views respectively showing a back side of an electronic camera in a non-photographing state according to the fifth embodiment, and a front side of the same in a photographing state,

FIG. 17 is an exploded perspective view of an imaging unit of the electronic camera,

FIGS. 18(a) and 18(b) are longitudinal sectional views of the imaging unit in the non-photographing state and the photographing state respectively,

FIGS. 19(a) and 19(b) are perspective views respectively showing a back side of an electronic camera in a non-photographing state according to the sixth embodiment, and a front side of the same in a photographing state,

FIG. 20 is an exploded perspective view of an imaging unit of the electronic camera,

FIGS. 21(a) and 21(b) are longitudinal sectional views of the imaging unit,

FIG. 22 is a perspective view showing a back side of an electronic camera in a photographing state according to the seventh embodiment of the present invention,

FIG. 23 is a sectional view showing the back side of the electronic camera,

FIGS. 24(a) and 24(b) are respectively an exploded perspective view of a mirror holder, and a perspective view of the same in a state that a reflection mirror is closed,

FIG. 25 is a sectional view showing a back side of an electronic camera according to the eighth embodiment of the present invention,

FIG. 26 is an explanatory view showing an area-panorama photographing,

FIG. 27 is an explanatory view showing a panorama image which is picked up by the area-panorama photographing shown in FIG. 26,

FIG. 28 is an explanatory view showing a line-panorama photographing, and,

FIG. 29 is an explanatory view showing a panorama image which is picked up by the line-panorama photographing shown in FIG. 28.

### DETAILED DESCRIPTION OF THE PREFERRED EMBODIMENT OF THE PRESENT INVENTION

This application is based on Patent Applications Nos. 9-092594, 9-092595 and 10-008955 filed in Japan, the contents of which are hereby incorporated by reference.

Now, the first embodiment of the present invention will be described in further detail by way of example with reference to the accompanying drawings.

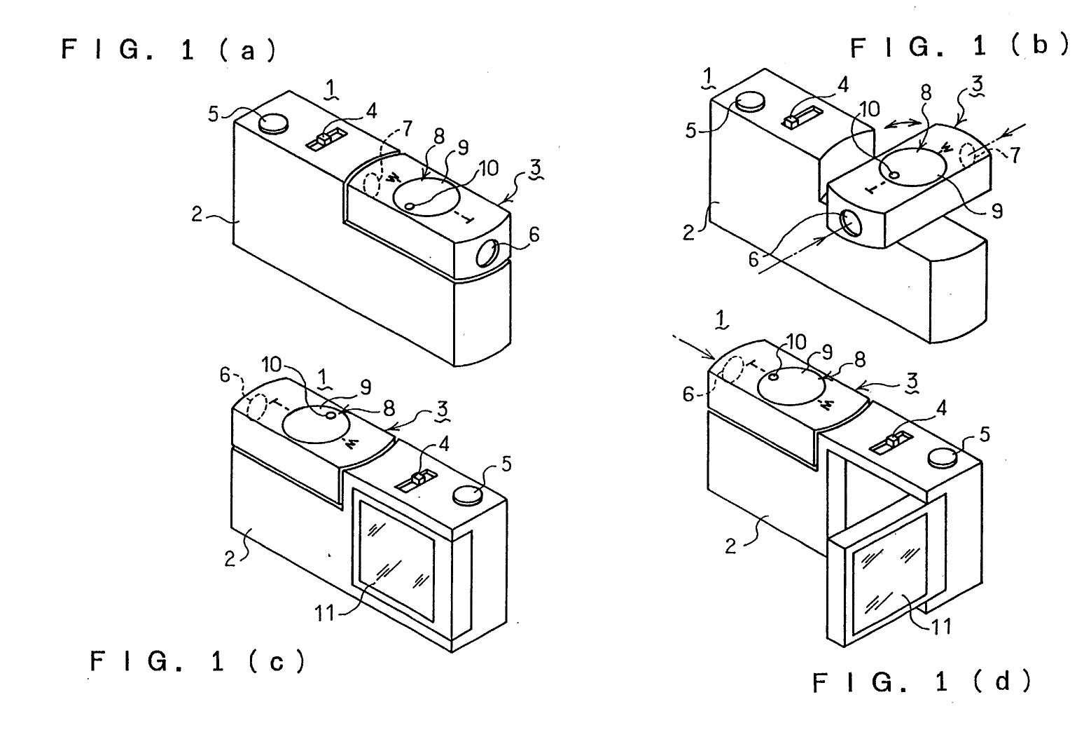

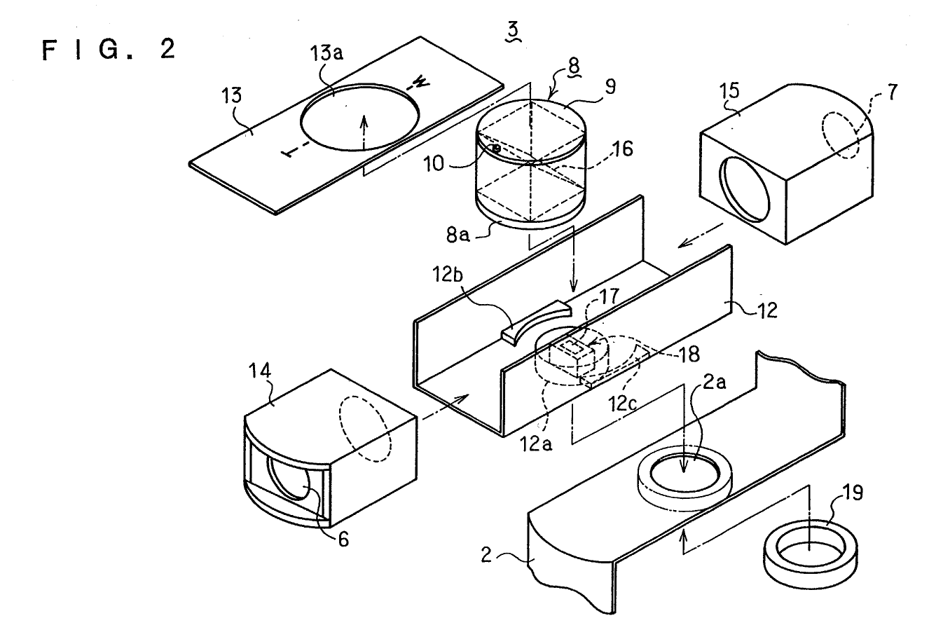

In FIGS. 1(a), 1(b) and 2, the electronic camera 1 comprises a flat camera body 2 which is thinnest in the back-and-forth direction, and the electronic camera 1 also comprises at the upper left the imaging unit 3 which is rotatable in the horizontal direction to an object to be photographed. The camera body 2 is provided with a power switch 4, shutter release button 5 etc. The imaging unit 3 has at both sides photographing lenses 6 and 7 respectively for a telephoto-mode and a wide-mode, and is rotatable in the horizontal direction unitedly with a rotational shaft which is vertical to an optical axis of the photographing lenses 6 and 7. In the above-described structure, photographing direction is changed over with fixing the camera body in a photographing operation as shown in FIG. 1(b). A chain-lined arrow in the figure denotes incident light in the photographing operation. The imaging unit 3 includes a prism 8 which is rotated by controlling a control knob on a control plate 9, thereby the photographing lens 6 or 7 is selected. Besides, the camera body 2 comprises on the back side a liquid crystal finder 11 which is opened pivoting on the rotational axis vertical to an optical axis of the photographing lenses 6 and 7.

Next, a structure of the imaging unit 3 will be explained in detail referring to FIG. 2. The imaging unit 3 comprises a rotatable lens barrel 12 and a top cover 13 which form a box-shape, and in both of right and left sides of the lens barrel 12 a lens holders 14 and 15 which respectively hold the telephoto-mode photography lens 6 and wide-mode photography lens 7. In such a construction, the prism 8 which is arranged between the photography lenses 6 and 7 on their optical axis, is rotated by a turning plate 8a, and supported by guide pieces 12b and 12c which are disposed on a bottom of the rotatable lens barrel 12. The top cover 13 covers the top of the rotatable lens barrel 12 such that the control plate 9 of the prism 8 is inserted into a hole 13a. Directly below the prism 8, there is provided a CCD (charge-coupled device) container 12a on the underside of the bottom of the rotatable lens barrel 12, which contains a CCD block 18 having a CDD 17. A light passing through the photographing lens 6 or 7 is reflected downward by a mirror surface 16 of the prism 8, thereby an object image is projected on the CCD 17. The CCD container 12a is inserted into a hole 2a on the upper left of the camera body 2, and supported by a bearing 19 which surrounds the hole 2a inside the camera body 2. Thus, the imaging unit 3 can be rotated in the horizontal direction unitedly with the rotation of the CCD container 12a.

In the above-described structure, the rotational lens barrel 12 is rotated unitedly with the CCD container 12a. Owing to the rotation of the lens barrel 12, the whole imaging unit 3 rotates unitedly with the rotational shaft which is vertical to the optical axis of the photographing lenses 6 and 7. Thereby, a photographing direction can be changed over into the right and the left with fixing the camera body 2. Besides, the photography lens 6 for the telephoto-mode can be used by the control knob 10 being set on “T (tele)” on the top cover 13. If the control knob 10 is set on “T”, a light that had passed through the telephoto lens 6 only, is reflected downward by the mirror surface 16 of the prism 8, thereby an object image is projected on the CCD 17. On the other hand, the photography lens 7 for the wide-mode can be used by the control knob 10 being set on “W (wide)” on the top cover 13. If the control knob 10 is set on “W”, a light that had passed through the wide angle lens 7 only, is reflected downward by the mirror surface 16 of the prism 8, thereby an object image is projected on the CCD 17.

In the above-described electronic camera 1, the imaging unit 3 of which rotational shaft is vertical to the optical axis of the photography lenses 6 and 7, is rotated in the horizontal direction, thereby the photographing direction can be changed over into the right and the left with fixing the camera body 2. Moreover, the camera body 2 is thinnest in the back-and-forth direction, so that a liquid crystal finder 11 can be located on the back surface of the camera body 2, which makes it easier for a photographer to see the finder display, and hold the camera in a photographing operation.

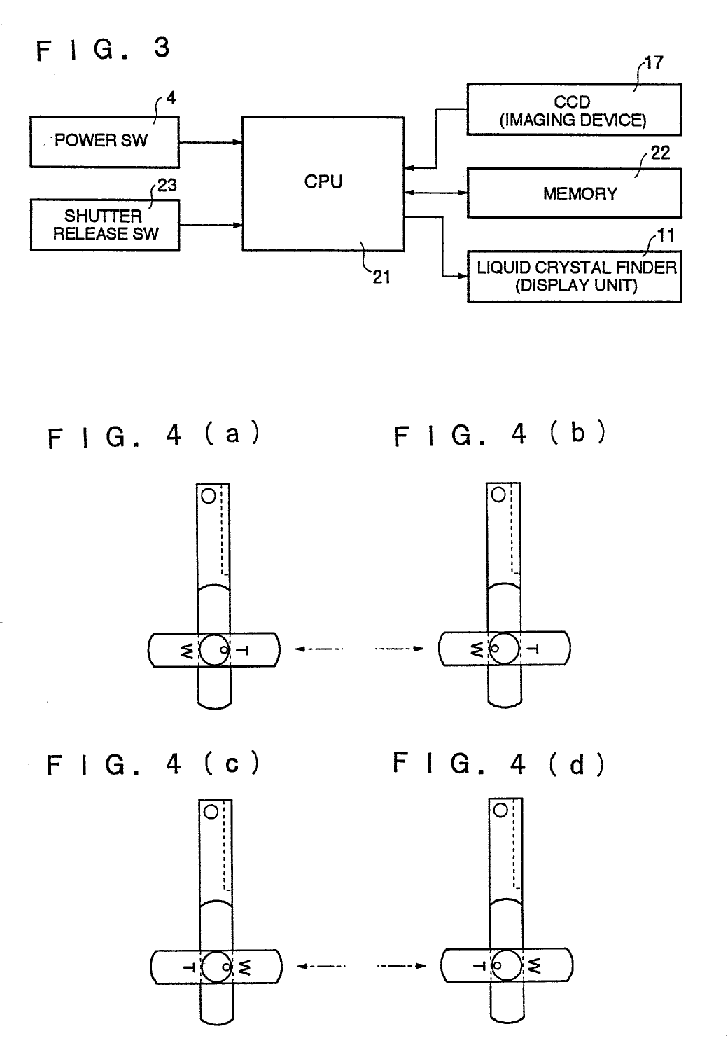

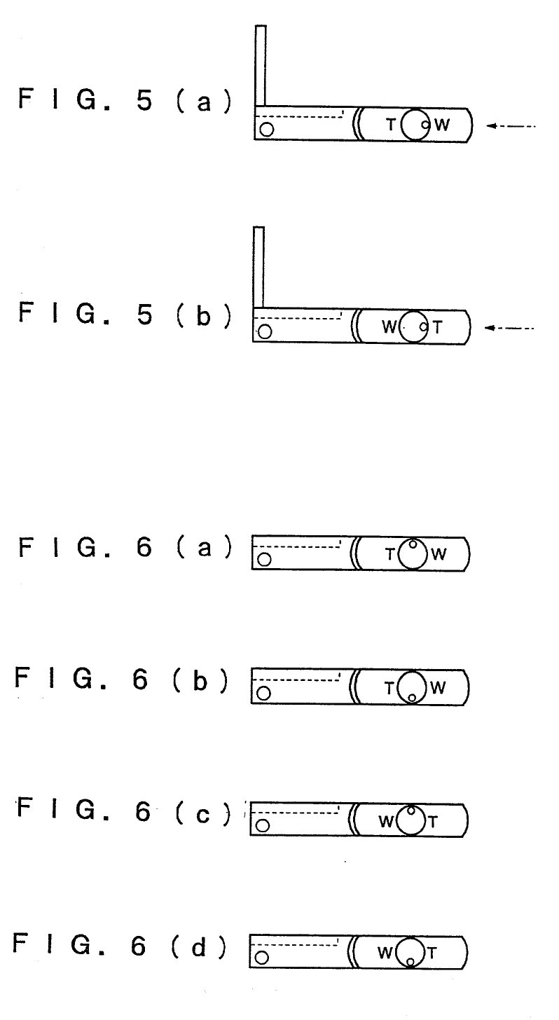

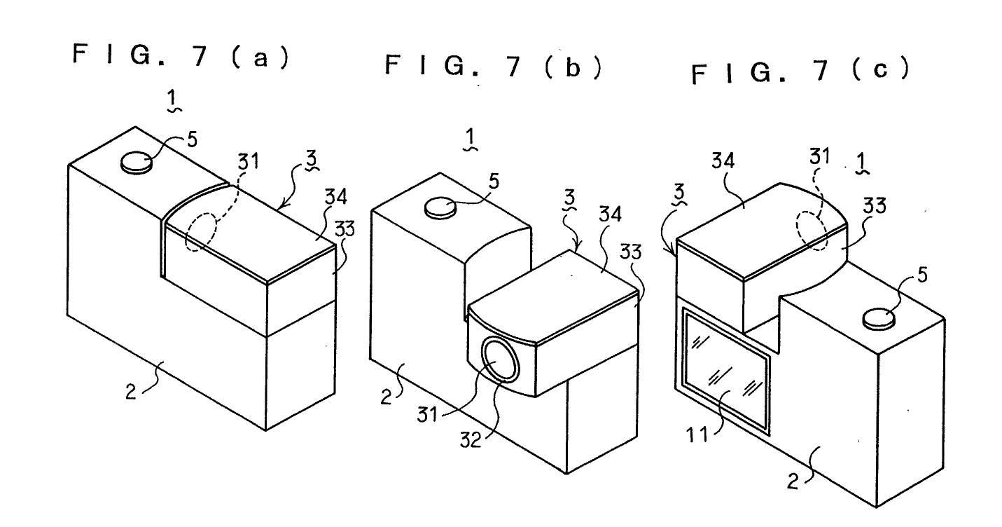

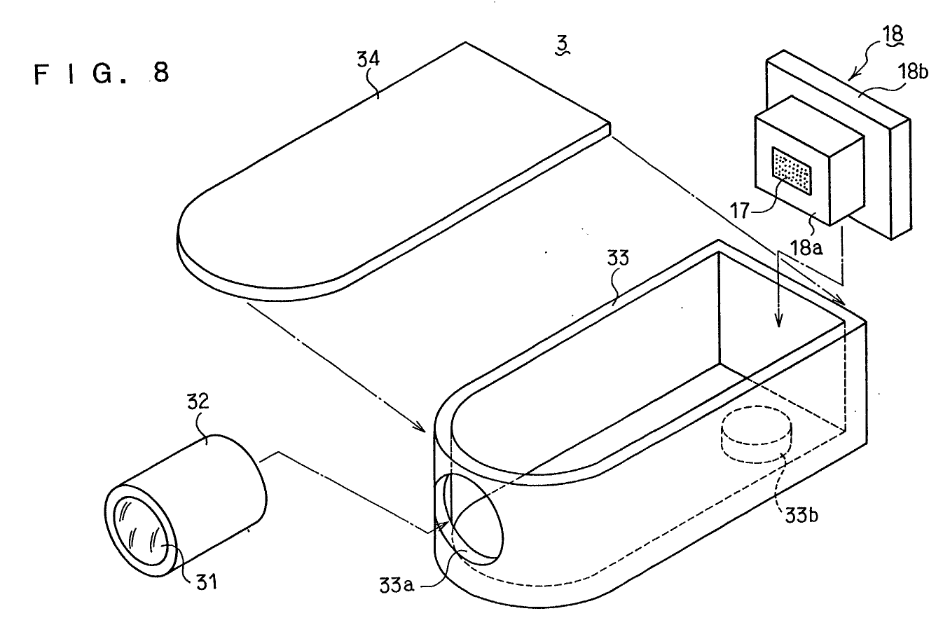

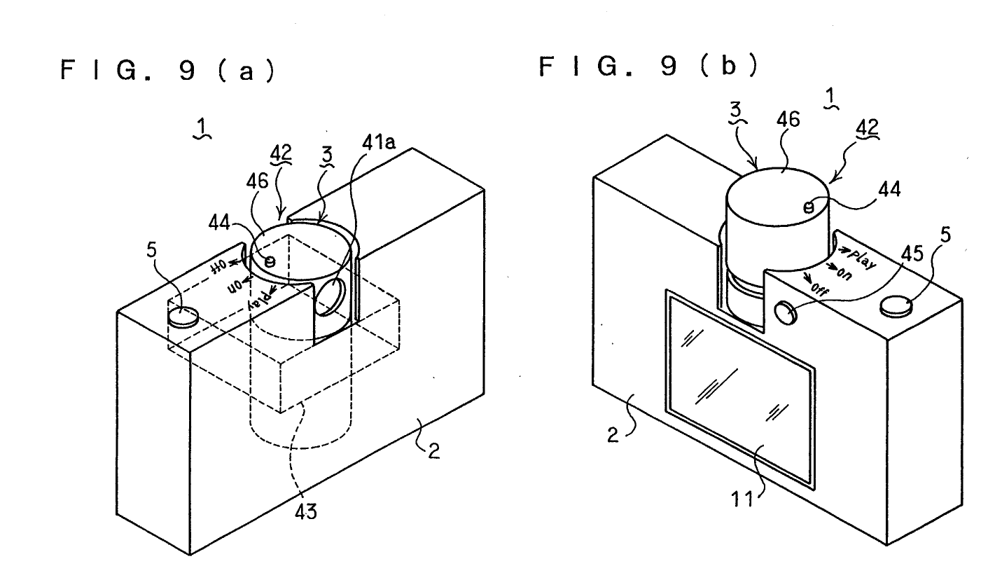

As shown in a block diagram of FIG. 3, the electronic camera 1 is provided with a CPU (central processing unit) 21 for controlling the entire action. The CPU 21 displays the image which is projected on the CCD 17 through the photography lens 6 or 7 in the photographing state when the power switch 4 is turned ON. Besides, in a photographing state, the CPU 21 detects a signal from a shutter release switch 23 which is turned ON when a shutter release button 5 is pressed, receives an electrical signal of the image on the CCD 17, and stores it in a memory 22. The electronic camera of this embodiment can be used in each of states shown in FIGS. 4(a)-4(d), and used in states shown in FIGS. 5(a) and 5(b) in which the finder door is opened. In FIGS. 4(a)-5(b), chain-lined arrows indicate incident light from the object to be photographed. FIGS. 6(a)-6(d) show patterns of the electronic camera in a non-photographing state.

Next, the second embodiment of the present invention will be described in detail with reference to FIGS. 7(a), 7(b), 7(c) and 8. It is to be noted that the same components as those of the first embodiment are denoted by the same reference numerals in the second embodiment. The imaging unit 3 has only one photography lens 31 of a pan-focus type which can achieve focus on an object at all locations from near to infinity. As in the case with the first embodiment, the imaging unit 3 of which rotational shaft is vertical to the optical axis of the photography lens 31, is rotated in the horizontal direction, thereby the photographing direction can be changed over into the right and the left with fixing the camera body 2.

As shown in FIG. 8, the imaging unit 3 comprises a rotatable lens barrel 33 and a top cover 34 which form a box-shape, and the rotatable lens barrel 33 is provided on its front surface with a hole 33a into which a cylindrical-shaped lens holder 32 for holding the photography lens 31 is inserted. Besides, there is also provided a CCD block 18 facing to the photography lens 31 in the imaging unit 3, which comprises a CCD 17 for converting an object image projected through the photography lens 31 into an electrical signal. The CCD block 18 has the CCD 17, a silicon base 18a and a mounting 18b for supporting the silicon base 18a. The rotational lens barrel 33 is equipped with a rotational shaft 33b on the underside of a bottom thereof. The rotational shaft 33b is inserted into a hole of the camera body 2, so that the rotational shaft 33b acts as a rotational shaft of the imaging unit 3, thus the imaging unit 3 can be rotated in the horizontal direction.

In the above-described structure, the photographing direction is changed over by rotating the rotatable lens barrel 33 unitedly with the rotational shaft 33b. Owing to the rotation of the rotatable lens barrel 33, the whole imaging unit 3 horizontally rotates unitedly with the rotational shaft which is vertical to the optical axis of the photographing lens 31. Thereby, the photographing direction can be changed over into the right and the left with fixing the camera body 2 as in the case of the first embodiment. Moreover, the camera body 2 is thinnest in the back-and-forth direction, so that the liquid crystal finder 11 can be located on the back surface of the camera body 2, which makes it easier for a photographer to see the finder display, and hold the camera in a photographing operation.

The explanation is nextly given to the third embodiment of the present invention with reference to FIGS. 9(a)-13. It is to be noted that the same components as those of the previously described embodiments are denoted by the same reference numerals in the third embodiment. The imaging unit 3 of the present embodiment comprises an imaging unit body 42 having an object-side lens 41a and an image-side lens 41b, and a click block 43 for positioning the imaging unit body 42. The imaging unit body 42 is furnished on the upper surface with a power switch/control knob 44 (hereinafter referred to as simply a control knob). If the control knob 44 is turned around in a power-OFF state, a condition is changed over into a power-ON state (photographing state) or a playback state. In the power-ON state, a photographing operation can be executed, and in the playback state, data in a memory 22 is played back, and displayed on a liquid crystal finder 11. When an up-down button 45 is pushed in the power-ON state, the imaging unit body 42 is moved upward as shown in FIG. 9(b). If the control knob 44 is turned around in this state, the photographing direction can be changed over into the right and the left with fixing the camera body 2.

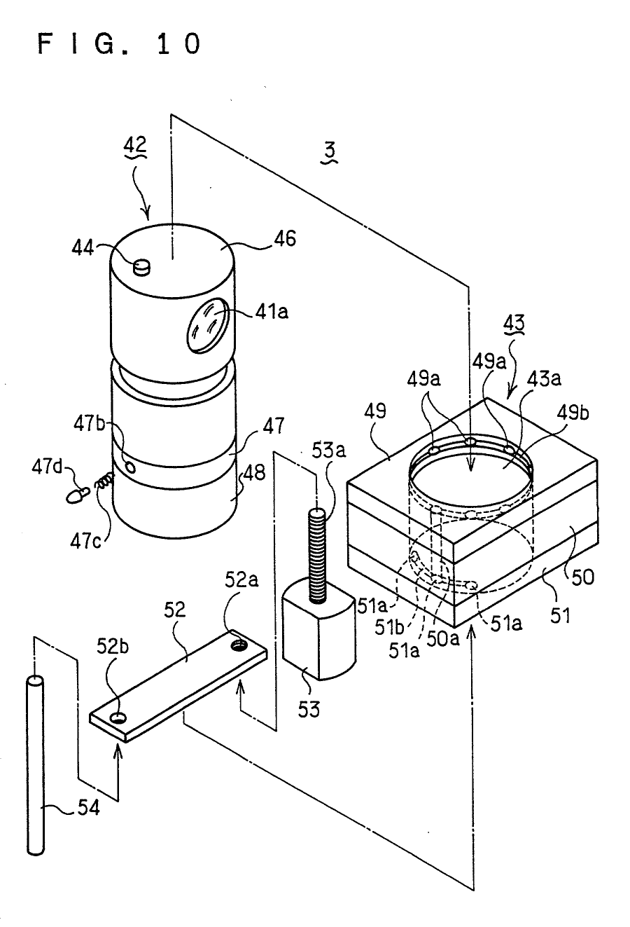

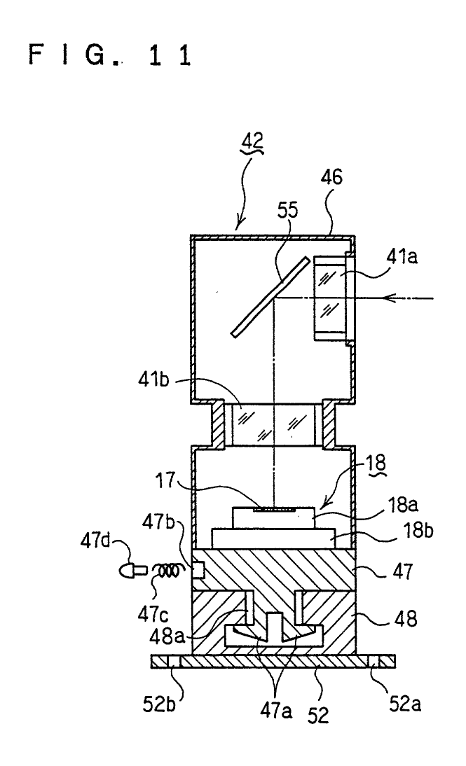

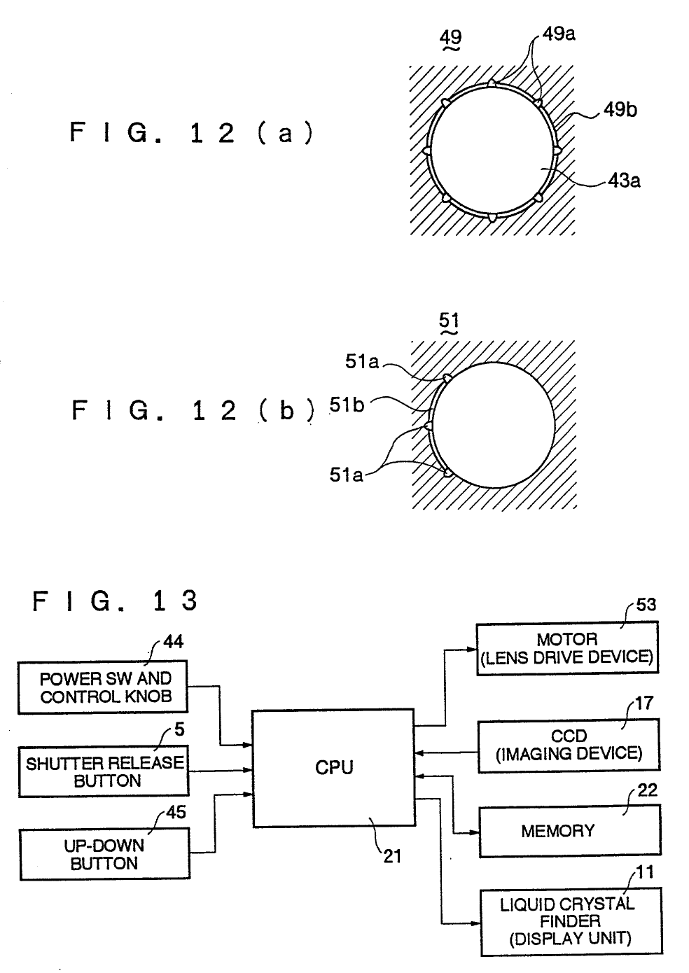

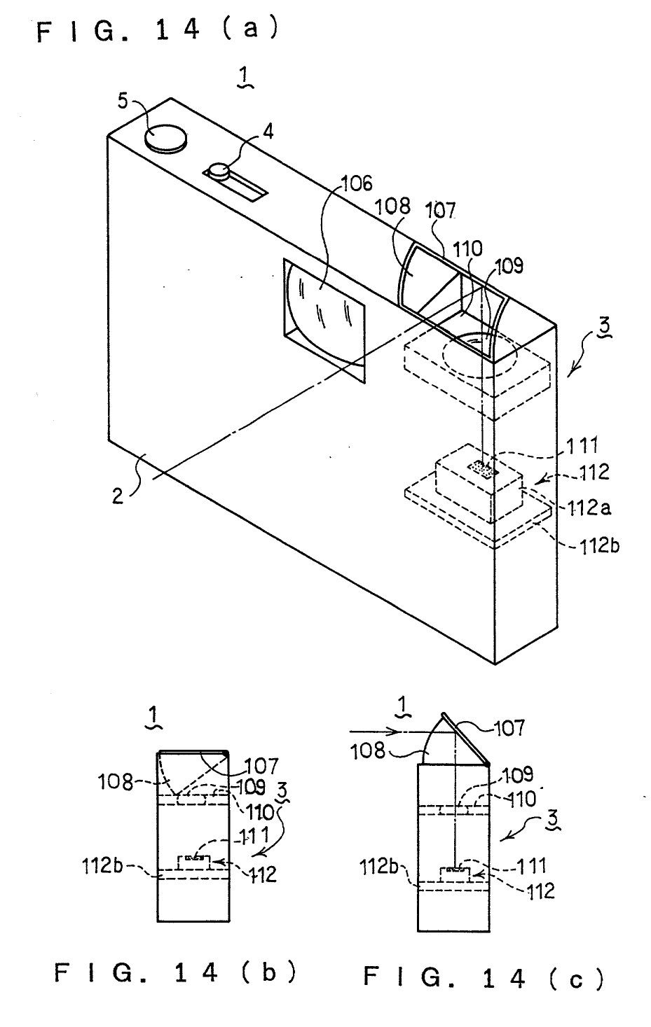

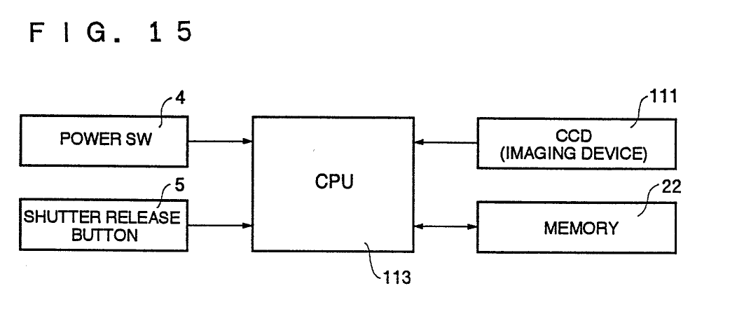

The imaging unit body 42 includes a cylindrical-shaped rotational lens barrel 46 which is supported by a rotational base 47 and a bearing 48. As shown in FIG. 10, the click block 43 is composed of an upper block 49, a middle block 50 and a lower block 51. The imaging unit body 42 is inserted into a hole 43a of the click block 43, and the bearing 48 which is protruded from the lower part of the click block 43, is supported on its lower part by a supporting plate 52. In a state that the imaging unit body 42 is movable upward and downward, it is engaged into the click block 43 by turning around the supporting plate 52. The supporting plate 52 has a screw hole 52b into which a screw-shaped rotational shaft 53a of a motor 53 is screwed, and a through hole 52b through which a guide bar 54 is inserted, thereby the supporting plate 52 is moved upward and downward by the guide bar 54 unitedly with the rotation of the motor 53. Thus, the whole imaging unit body 42 which is supported by the supporting plate 52, can be moved upward and downward. The rotational lens barrel 46 and the rotational base 47 which compose an upper part of the imaging unit 42, can be rotated on the bearing 48 and the supporting plate 52, and is fixed by a pin 47d of the rotational base 47 being engaged into one of upper pits 49a on the upper side of the upper block 49. By means of the rotational lens barrel 46 being fixed as mentioned above, the photographing direction is fixed. When the pin 47d is engaged into one of lower pits 51a of the lower block 51, the power-ON/OFF state or the playback stated is selected.

Further, a detailed structure of the imaging unit body 42 is described referring to FIG. 11. The rotational lens barrel 46 of the imaging unit body 42 is furnished with the object-side lens 41a on the periphery, and contains a mirror 55 onto which a light passing through the object-side lens 41a is reflected, and the image-side lens 41b which gathers the reflected light from the mirror 55 onto a CCD 17. Although the object-side lens 41a and the image-side lens 41b are illustrated in flat shape in the figures, they are formed in proper shapes to have a function for gathering lights in the actual camera. Besides, the rotational base 47 is united with a fixed CCD block 18, has on the periphery a spring-receiving hole 47b into which a pin 47d is inserted through a spring 47c. The rotational base 47 has on the lower side engagement claws 47a which engages into a hollow 48a of the bearing 48, thereby the rotational base is supported by the bearing 48.

The imaging unit body 42 is in the non-photographing state such that the pin 47d of the rotational base 47 is engaged into the lower pit 51a for the “OFF” state (refer to FIG. 12(b)). The non-photographing state is changed over into the photographing state when the control knob 44 is set on “ON” position, and the rotational base 47 of the imaging unit body 42 is rotated in the counterclockwise direction. Thereby, the pin 47d of the rotational base 47 goes in a lower groove 51b which is arranged on the lower block 51, and then engaged into the lower pit 51a for the “ON” state. Thus, the power is turned ON, which enables to photograph.

The photographing direction is changed over by a following procedure. First of all, pushing the up-down button 45, the motor 53 is driven, thereby the rotational shaft 53a is rotated. As the rotational shaft 53a rotates, the supporting plate 52 for supporting the imaging unit body 42 is moved upward. Unitedly with the supporting plate 52, the pin 47d of the rotational base 47 slides upward in an up-down groove 50a which is arranged in the middle block 50, and then the pin 47d is inserted into the one of upper pits 49a which are located on the upper end of the up-down groove 50a. Thus, the imaging unit body 42 is engaged with the upper block 49. Turning the control knob 44 in this state, the pin 47d slides in an upper rotation groove 49b which connects the 8 upper pits 49a (refer to FIG. 12(a)). A photographer can change over the photographing direction by selecting an arbitrary one of the 8 upper pits 49a, and inserting the pin 47d into the selected upper pit 49a.

The rotational lens barrel 46 of the imaging unit body 42 can be put inside the camera body 2 if the control knob 44 is set on the “ON” position in a state that the rotational lens barrel 46 is in the upper position, and the pin 47d is inserted into the upper pit 49a for the “ON” state. After that, pushing the up-down button 45, the pin 47d slides downward in the up-down groove 50a of the middle block 50, and then the pin 47d is inserted into the one of lower pits 51a which are located on the lower end of the up-down groove 50a. Thus, the imaging unit body 42 is engaged with the lower block 51, and put inside the camera body 2. On the other hand, the playback state is selected by setting the control knob 44 on the “PLAY” position, and rotating the rotational base 47 further counterclockwise. Thereby, the pin 47d, being moved in the same way as mentioned above, is inserted into the lower pit 51a for the “PLAY” state, which makes the playback state.

In the electronic camera 1 of the third embodiment, the imaging unit 3 has a rotational axis which is vertical to an optical axis of the object-side lens 41a, thus the imaging unit 3 can be rotated in the horizontal direction. Accordingly, the same effect as the above-described embodiments can also be achieved.

As shown in FIG. 13, a block diagram of a control circuit of the electronic camera 1 according to the third embodiment is similar to the block diagram shown in FIG. 3 of the first embodiment. However, in the present embodiment, the electronic camera 1 comprises the up-down button 45 and the motor 53. In the photographing state when the power switch/control knob 44 is set on the “ON” position, the CPU 21 detects the up-down button 45 pushed, and commands the motor (lens drive device) 53 to be driven. Thereby the imaging unit body 42 is moved, or put in the camera body 2.

In the electronic camera 1 in the above-described first, second and third embodiments, the photographing direction of the imaging unit 3 is manually changed over. However, it is also possible to compose a structure in which the photographing direction is changed over by the motor rotating the rotational lens barrels 12, 13 and 46.

Now, the fourth embodiment of the present invention is explained in detail with reference to FIGS. 14(a)-15 as follows. As shown in these figures, the electronic camera 1 is equipped with an imaging unit 3 in the right side thereof, and comprises a flat camera body 2 which includes a power switch 4, a shutter release button 5, an optical viewfinder 106, etc. The imaging unit 3 is provided with a reflection mirror 107, a lid 108 holding the reflection mirror, a photography lens 109, a lens holder 110 and a CCD block 112. In such a construction, the reflection mirror 107 deflects a light flux from the object, the light reflected by the reflection mirror 107 is projected through the photography lens 109, and the CCD block 112 is arranged below the lens holder 110. The lid 108, of which one end is supported by the camera body 2, is structured so as to be openable upward. The CCD block 112 includes a CCD (imaging device) 111 for converting the image into an electrical signal, a silicon base 112a and a mounting 112b on which the silicon base 112a is mounted.

In the above-described structure, the lid 108 is closed in the non-photographing state as shown in FIG. 14(b), so that a light flux from the object to be photographed does not enter into the photography lens 109. This non-photographing state is changed over into the photographing state by the lid 108 being opened upward as shown in FIG. 14(c). The lid 108 being opened, the light flux from the object to be photographed reaches the reflection mirror 107, and is deflected downward into the photography lens 109. Thereby the object image is projected on the CCD 111. Since the photography lens 109 and the CCD 111 are aligned in the vertical direction, the camera body 2 can be thinned in the photographing direction, and more specifically, the imaging unit 3 can be compacted in size by use of the reflection mirror 107. On the contrary, the photographing state can be changed over into the non-photographing state by the lid 108 being closed downward. The lid 108 being closed downward, the lid 108 with the reflection mirror 107 is folded inside the camera body 2, so that the light flux from the object to be photographed does not enter into the reflection mirror 107, the photography lens 109 and the CCD 111.

In the electronic camera of the present embodiment, the lid 108 which includes the reflection mirror 107, can be put inside the camera body 2 in the non-photographing state as mentioned above, therefore, the camera body 2 can be downsized, and besides, the photographing lens 109 can be protected by the lid 108.

As shown in a block diagram of FIG. 15, the electronic camera of the present embodiment comprises a CPU 113 for controlling the entire action of the electronic camera 1. In the photographing state when the power switch 4 is turned ON, the CPU 113 detects a signal from a release switch 5a which is turned on by the shutter release button 5 pushed, receives an electrical signal of the image on the CCD 111, and then records it in the memory 22.

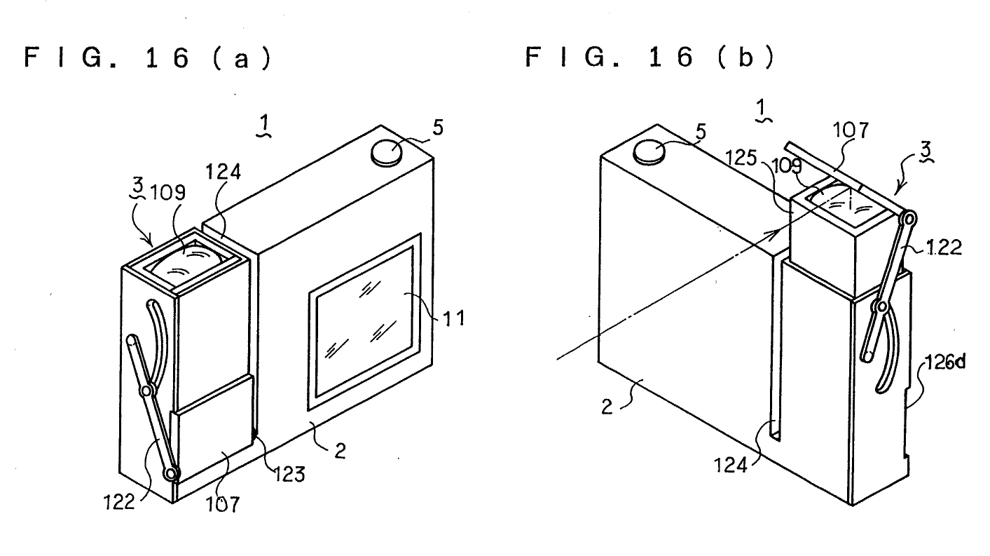

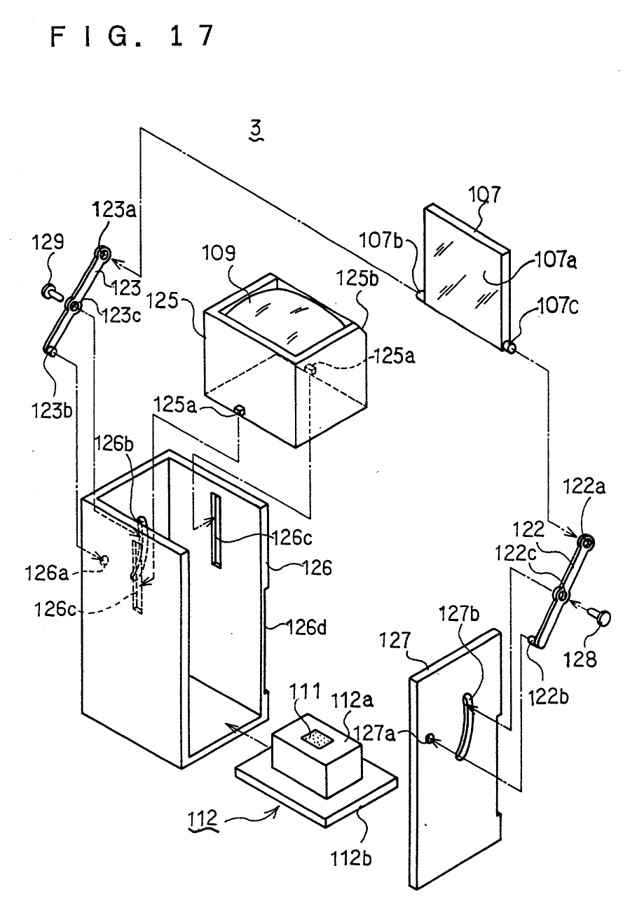

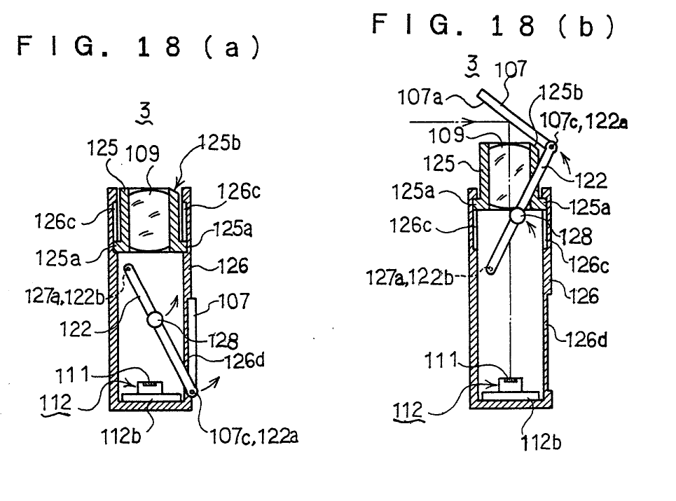

Then, the fifth embodiment of the present invention will be explained in the paragraphs that follow with reference to FIGS. 16(a)-18(b). It is to be noted that the same components as those of the previously described embodiments are denoted by the same reference numerals in the fifth embodiment. The electronic camera 1 of the present embodiment is furnished with a liquid crystal finder 11 on the back side of a camera body 2 as a substitute for the optical viewfinder 106 of the fourth embodiment. Besides, the electronic camera 1 is structured such that, moving upward a reflection mirror 107 which is folded in the back surface of the imaging unit 3, guide bars 122 and 123 which are located respectively on the right and left sides of the imaging unit 3, are rotated in the counterclockwise direction in FIGS. 16(a) and 16(b), with which, a lens holder 125 is protruded upward unitedly.

The imaging unit 3 is provided with the box-shaped lens holder 125 which holds the photography lens 109 in the top part, and a box-shaped case 126 which has a pair of slide grooves 126c on the inside wall thereof. The lens holder 125 is supported so as to be slidable upward and downward by sliding pieces 125a of the lens holder 125 inserted in the slide grooves 126c. The case 126 also holds on the bottom a fixed CCD block 112 including a CCD 111, and is covered on its one side by a side plate 127.

The pair of the guide bars 122 and 123 are connected into the case 126 and the side plate 127 by a projection 122b of the guide bar 122 engaging into a hole 127a of the side plate 127, and a projection 123b of the guide bar 123 engaging into a hole 126a of the case 126. The reflection mirror 107 and the lens holder 125 are moved unitedly with each other by these guide bars 122 and 123, and pins 128 and 129. More concretely, projections 107c and 107b of the reflection mirror 107 are respectively inserted into a hole 122a of the guide bar 122 and a hole 123a of the guide bar 123, and the pin 128 and the pin 129 are respectively inserted into a hole 122c of the guide bar 122 and a hole 123c of the guide bar 123. In this state, the guide bars 122 and 123 are slidably inserted into a guide slit 127b of the side plate 127 and a guide slit 126b of the case 126 respectively. Thereby, when the reflection mirror 107 is moved upward, which slides the pins 128 and 129 upward in the guide slits 127b and 126b, the pins 128 and 129, contacting the under plane of the lens holder 125, lift up the lens holder 125.

In the non-photographing state as shown in FIG. 18(a), the lens holder 125 is put in the case 126, and the reflection mirror 107 in a recess 126d of the case 126. At the time, the photography lens 109 and the CCD 111 cannot receive the light flux from the object to be photographed, and cannot keep an enough distance for a photographing operation between each other. This state is changed over into the photographing state by the reflection mirror 107 rotated in the counterclockwise direction in the figure. Owing to the rotation of the reflection mirror 107, the guide bars 122 and 123 are also rotated in the counterclockwise direction, with which, the pins 128 and 129 are slid in the guide slits 127b and 126b in the same direction. At this time, the pins 128 and 129 lift up the lens holder 125 with contacting the under surface of the lens holder 125. Thereby, the sliding pieces 125a of the lens holder 125 moves upward inside the slide groove 126c, which makes the lens holder 125 pop up from the case 126. Then, in the photographing state as shown in FIG. 18(b), the light flux from the object is deflected by a mirror surface 107a, and entered into the photography lens 109, which projects the object image on the CCD 111. At the time, the photography lens 109 projecting from the case 126, the photography lens 109 and the CCD 111 keep an enough distance for a photographing operation between each other. Besides, the lens holder 125 has on its upper end edge a cut-off plane 125b on which the mirror surface 107a is loaded in the photographing state in order to stabilize the light flux in a state of being deflected at the right angle. The mirror surface 107a can be moved until it contacts with the cut-off plane 125b. Thereby, the photographing range is slightly adjusted upward and downward.

On the contrary, the photographing state is changed over into the non-photographing state by the reflection mirror 107 rotated in the clockwise direction in the figure. The reflection mirror 107 being rotated like this, the lens holder 125 is put in the case 126, and the reflection mirror 107 in the recess 126d of the case 126, so that the photography lens 109 and the CCD 111 cannot receive the light flux from the object to be photographed.

As described above, the lens holder 125 is moved into the inside of the imaging unit 3 from the outside thereof unitedly with the reflection mirror 107 being moved into the recess 126d in the electronic camera according to the fifth embodiment. Thereby, the camera body 2 can be thinned in the photographing direction and shortened in the vertical direction in the non-photographing state, so that the camera body 2 can be compacted in the non-photography state.

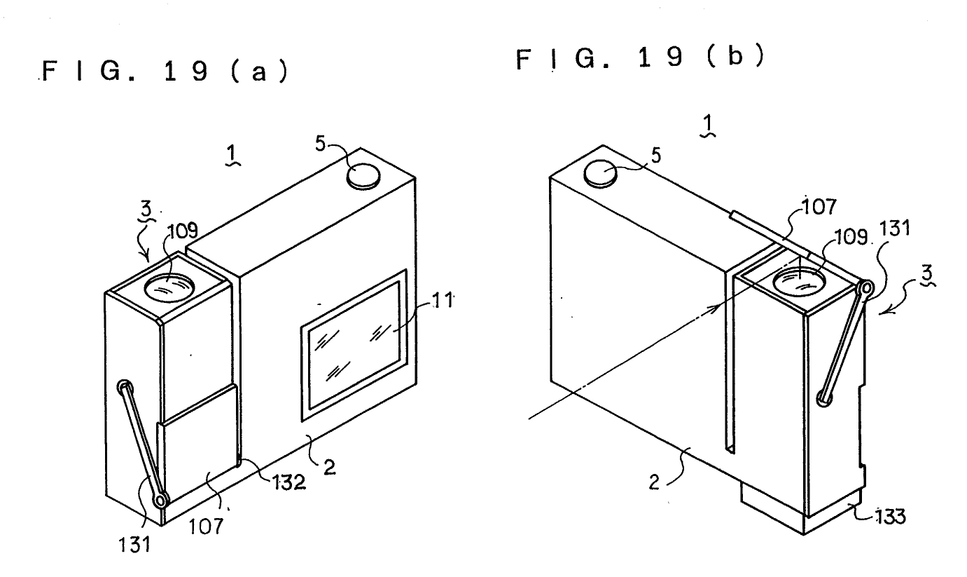

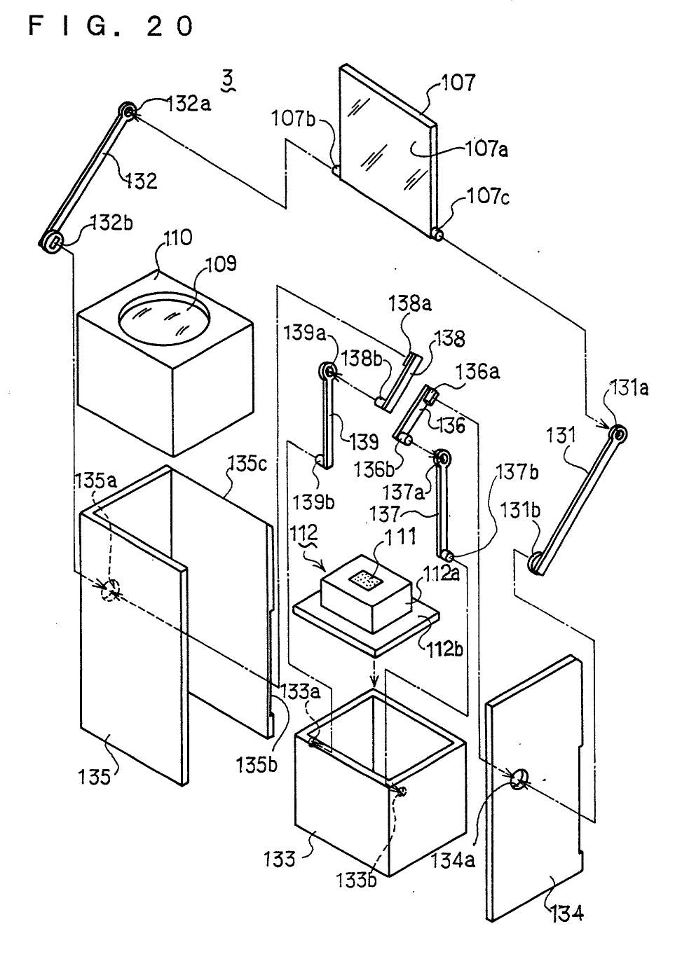

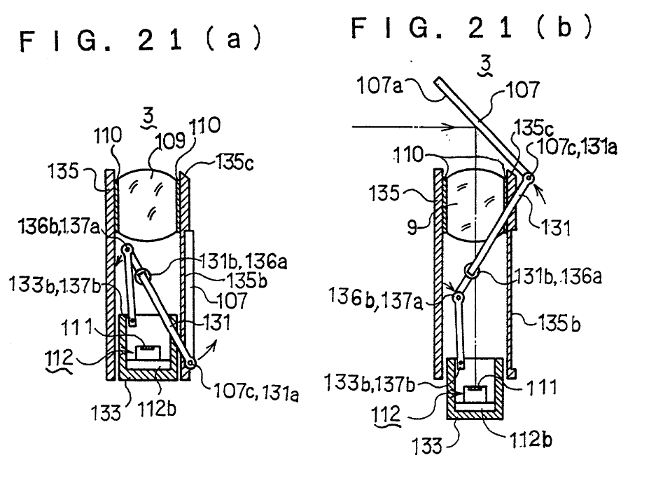

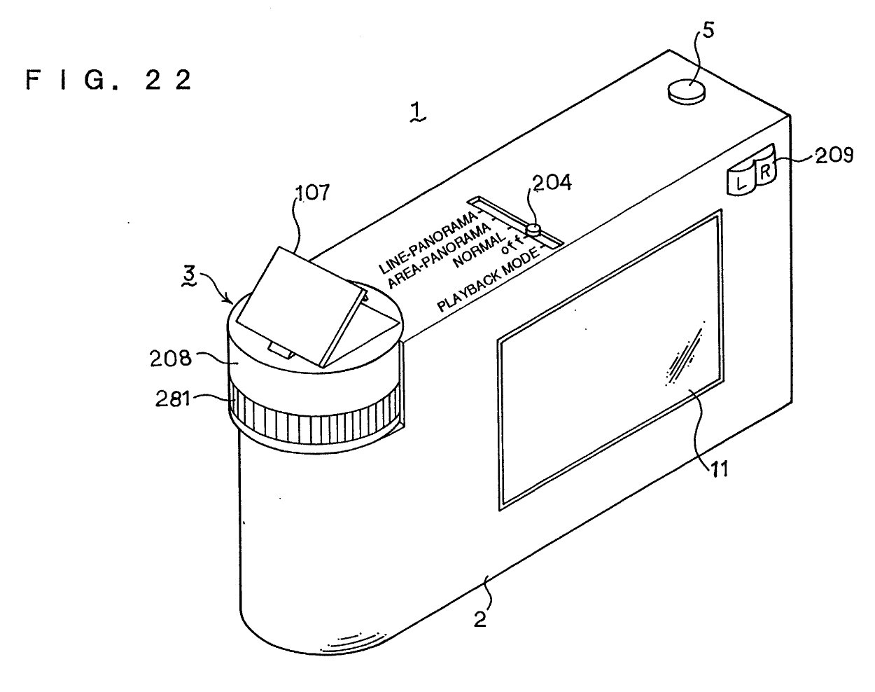

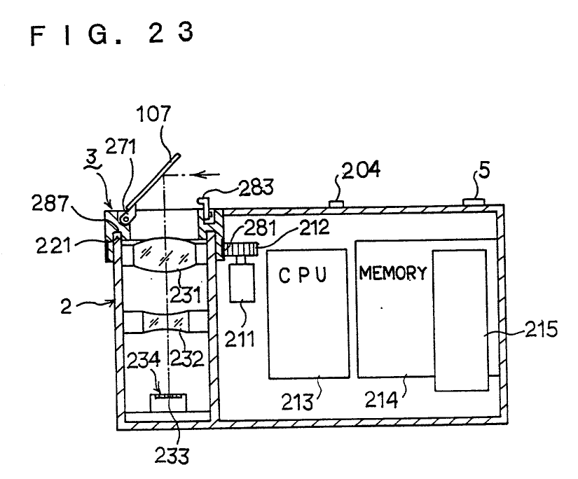

Next, the sixth embodiment is explained with reference to FIGS. 19(a) to 21(b) as follows. It is to be noted that the same components as those of the previously described embodiments are denoted by the same reference numerals in the sixth embodiment. The electronic camera 1 is structured such that, moving upward a reflection mirror 107 which is folded in the back surface of the imaging unit 3, guide bars 131 and 132 which are located respectively on right and left sides of the imaging unit 3, are rotated in the counterclockwise direction in FIGS. 19(a) and 19(b), with which, a CCD holder 133 is projected downward unitedly.

The imaging unit 3 is formed like a box by a side plate 134 and a case 135, and includes a lens holder 110 for holding a photography lens 109 inside thereof. The CCD holder 133 for holding a CCD package 112 is put in the case 135 in the non-photographing state, and projected downward in the photographing state. The reflection mirror 107 has a mirror surface 107a, and on both side ends projections 107c and 107b which are respectively inserted into a hole 131a of the guide bar 131 and a hole 132a of the guide bar 132. The reflection mirror 107 is rotatably supported by the side plate 134 and the case 135 through the guide bars 131 and 132 by means of projections 131b and 132b of the guide bars 131 and 132 respectively engaging into a holes 134a and 135a of the side plate 134 and the case 135. The reflection mirror 107 is folded in a recess 135b of the case 135 in the non-photographing state and moved upward over the imaging unit 3 in the photographing state.

The above-mentioned reflection mirror 107 is connected with the CCD holder 133 through the guide bars 131 and 132, and guide bars 136, 137, 138 and 139 which are connected with each other. More concretely, the guide bar 131 from outside and the guide bar 136 from inside, sandwiching the side plate 134 through a hole 134a of the side plate 134, are connected with each other by a projection 131b of the guide bar 131 and a projection 136a of the guide bar 136 engaging with each other; the guide bar 136 and the guide bar 137 are connected with each other by a pin 136b of the guide bar 136 being inserted in a hole 137a of the guide bar 137; and the guide bar 137 and the CCD holder 133 are connected with each other by a pin 137b of the guide bar 137 being inserted in a hole 133b arranged on an inside wall of the CCD holder 133. In the same manner, the guide bar 132 from outside and the guide bar 138 from inside, sandwiching one side of the case 135 through a hole 135a of the case 135, are connected with each other by a projection 132b of the guide bar 132 and a projection 138a of the guide bar 138 engaging with each other; the guide bar 138 and the guide bar 139 are connected with each other by a pin 138b of the guide bar 138 being inserted in a hole 139a of the guide bar 139; and the guide bar 139 and the CCD holder 133 are connected with each other by a pin 139b of the guide bar 139 being inserted in a hole 133a arranged on an inside wall of the CCD holder 133.

In the above-explained structure, the CCD holder 133 is put in the case 135, and the reflection mirror 107 in the recess 135b of the case 135 in the non-photographing state as shown in FIG. 21(a). At the time, the photography lens 109 and the CCD 111 cannot receive the light flux from the object to be photographed, and cannot keep an enough distance for a photographing operation between each other. This state is changed over into the photographing state by the reflection mirror 107 rotated in the counterclockwise direction in the figure. Owing to the rotation of the reflection mirror 107, the guide bars 131 and 136 are unitedly rotated in the counterclockwise direction centering on a junction of the projection 131b and the projection 136a, and a junction of the pin 136b of the guide bar 136 and the hole 137a of the guide bar 137 is rotated downward. Thereby the CCD holder 133 which is connected with the guide bar 137, is projected downward from the case 135. Simultaneously with the above-described movement, the guide bars 132, 138 and 139 which are respectively located on an opposite side of the guide bars 131, 136 and 137, are moved in the same manner, which projects the CCD holder 133 downward from the case 135.

Then, in the photographing state as shown in FIG. 21(b) that the reflection mirror 107 is rotated over the imaging unit 3, the light flux from the object is deflected by a mirror surface 107a, and entered into the photography lens 109, which projects the object image on the CCD 111. At the time, the CCD holder 133 projecting downward, the photography lens 109 and the CCD 111 keep an enough distance for a photographing operation between each other. Besides, the case 135 has a cut-off plane 135c on its upper end edge just as the lens holder 125 of the fifth embodiment has the cut-off plane 125b. The mirror surface 107a can be moved until it contacts with the cut-off plane 135c. Accordingly, the photographing range is slightly adjusted upward and downward as in the case with the fifth embodiment.

On the contrary, the photographing state is changed over into the non-photographing state by the reflection mirror 107 rotated in the clockwise direction in the figure. The reflection mirror 107 being rotated like this, the CCD holder 133 is put inside the case 135, and the reflection mirror 107 in the recess 135b of the case 135, so that the photography lens 109 and the CCD 111 cannot receive the light flux from the object to be photographed.

As described above, the CCD holder 133 is moved into the inside of the imaging unit 3 from the outside thereof unitedly with the reflection mirror 107 being moved into the recess 135b in the electronic camera according to the sixth embodiment. Thereby, the camera body 2 can be thinned in the photographing direction and shortened in the vertical direction in the non-photographing state, so that the camera body 2 can be compacted in the non-photographing state.

In the electronic camera 1 in the above-described fifth and sixth embodiments, the photographing range is slightly adjusted upward and downward by moving the mirror surface 107a until it contacts with the cut-off plane 125b of the lens holder 125 or the cut-off plane 135c of the case 135. However, it is also possible to compose a structure in which a photographing operation is executed only in a state that the mirror surface 107a contacts with the cut-off plane 125b or 135c, and loads on the lens holder 125 or the case 135.

Now, the explanation is nextly given to the seventh embodiment of the present invention with reference to FIGS. 22 to 24(b).

As shown in FIG. 22, the electronic camera 1 has a flat camera body 2 which is thinnest in the back-and-forth direction, and furnished with an imaging unit 3 on the left side thereof. The camera body 2 is equipped on the top with a power and mode-selector switch (hereinafter referred to as simply a selector switch) 204, and a shutter release button 5, and on the back surface with a liquid crystal finder 11 and a mirror-rotation control switch 209. The selector switch 204 which changes over between ON and OFF, also acts as a mode selector between a normal photography mode, an area-panorama photography mode, a line-panorama photography mode and a playback mode (each mode will be described together with that of the eighth embodiment later).

The imaging unit 3 comprises a reflection mirror 107 for deflecting a light flux from an object to be photographed, and a mirror holder 208 for holding the reflection mirror 107 and passing the light reflected by the reflection mirror 107. The reflection mirror 107 which is held on its one end by the mirror holder 208, has a pop-up structure that another end opens upward and closes downward. The mirror holder 208 is arranged so as to rotate around a vertical axis (rotate in the horizontal direction). In other words, the reflection mirror 107 can be projected out of the imaging unit 3, and rotated around an optical axis of the light reflected by the reflection mirror 107.

In the above-mentioned structure, when the selector switch 204 is set on the normal photography mode, and the mirror-rotation control switch 209 is operated, the mirror holder 208 is driven to rotate horizontally by a later-described motor 211 (refer to FIG. 23). Thereby, the photographing direction can be changed over into the right and the left with respect to an object in front of the electronic camera 1 with fixing the camera body 2. When the selector switch 204 is set on the area-panorama mode or the line-panorama mode, and the shutter button 5 is pushed, the mirror holder 208 is also rotated in the same manner.

Next, the inside structure of the imaging unit 3 is explained referring to FIG. 23. The imaging unit 3 contains under the reflection mirror 107 an optical system including photography lenses 231 and 232, and a CCD block 234 which are arranged along with the optical axis vertically to the photographing direction. These photography lenses 231 and 232 are a pan-focus type which can achieve focus on an object at all locations from near to infinity. The CCD block 234 also comprises a CCD 233 (imaging device) which converts an image projected through the photographing lenses 231 and 232 into an electrical signal.

The mirror holder 208 can be rotated right and left by an arc-shaped groove 287 on the underside thereof and an arc-shaped projection 221 of the camera body 2 engaging with each other. The camera body 2 includes a motor 211 and a gear 212 which receives a rotational shaft of the motor 211, and gears with teeth 281 arranged around the mirror holder 208. If the mirror-rotation control switch 209 or the shutter release button 5 is pushed down, the gear 212 and the mirror holder 208 are rotated with the motor 211 rotating, with which, the reflection mirror 107 changes over the photographing direction. In the above-mentioned operation for changing over the photographing direction, only the mirror holder 208 holding the reflection mirror 107 is driven to rotate, so that a smaller driving force is enough for changing over the photographing direction than in that case that the entire imaging unit 3 is driven to rotate. Further, the structure that the pop-up reflection mirror 107 is rotated around the optical axis of the optical system, makes it possible to photograph all the objects surrounding the electronic camera with the simple optical system having the only one reflection mirror 107.

The electronic camera 1 comprises a CPU 213 for controlling the entire action thereof, a memory 214 and a battery 215 for power supply in the camera body 2. The CPU 213 displays the image on a liquid crystal finder 11 in the photographing state that the selector switch is set on the normal photography mode, area-panorama photography mode or the line-panorama photography mode. In the photographing state when the shutter release button 5 is depressed downward, the CPU 213 receives an electrical signal of the image which is projected on the CCD 233 through the photography lenses 231 and 232, and then records it in the memory 214.

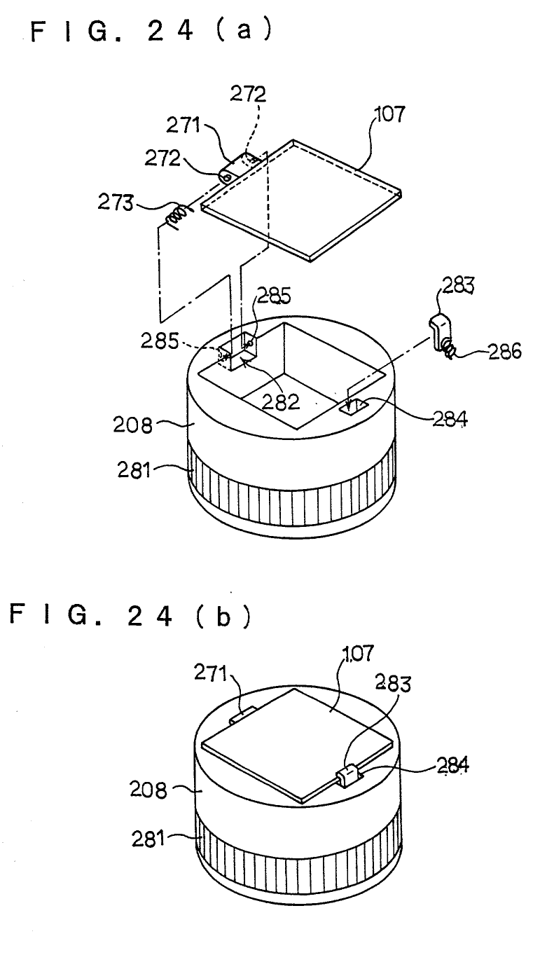

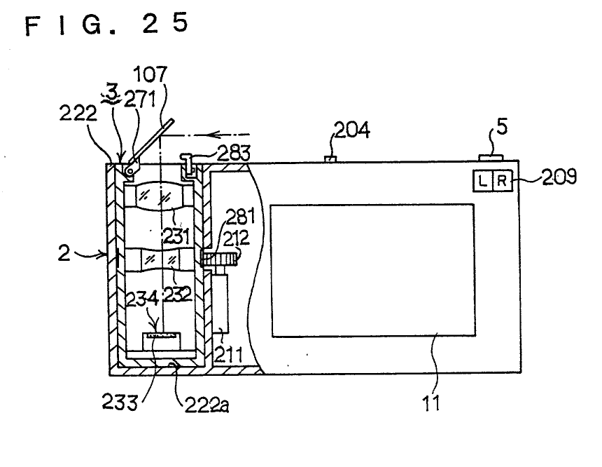

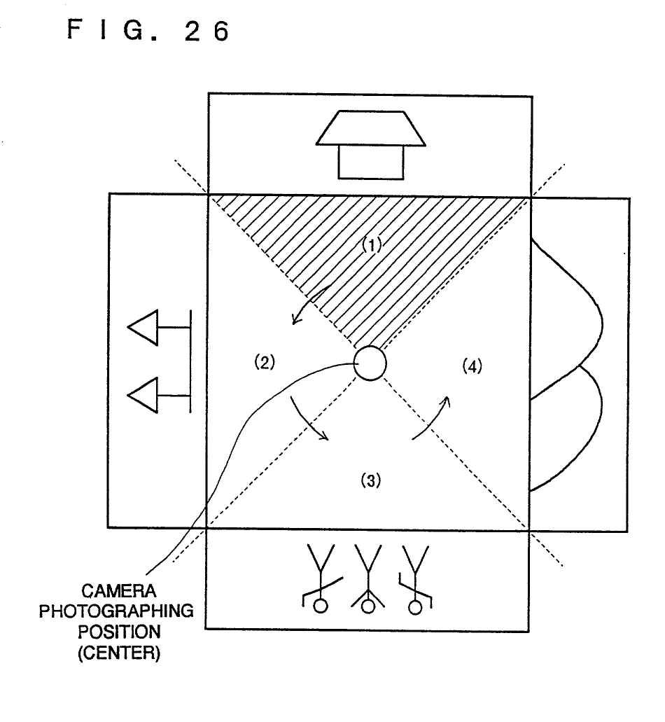

Then, the detailed structure of the mirror holder 208 is explained with reference to FIGS. 24(a) and 24(b). The reflection mirror 107 is openably supported by the mirror holder 208 in a state that pivots 272 of a projection 271 arranged on one end of the reflection mirror 107 are inserted into a pit 285 of a depression 282 arranged on the mirror holder 208. One of the pivots 272 is coiled around by a coil spring 273 which urges the reflection mirror 107 to open, and keeps it in the opening state. Further, the mirror holder 208 has an engagement piece 283 which is arranged in another depression 284 opposite to the depression 282, and urged in the direction toward the reflection mirror 107 by a coil spring 286, thereby the reflection mirror 107 is kept in the closing state.

Then, the eighth embodiment of the present invention is explained with reference to FIG. 25 as follows. It is to be noted that the same components as those of the previously described embodiments are denoted by the same reference numerals in the eighth embodiment. Although the electronic camera of the seventh embodiment has a structure that the photographing direction is changed over by rotating only the mirror holder 208 with the reflection mirror 107, the electronic camera of the eighth embodiment has a structure that the photographing direction is changed over by rotating the entire imaging unit 3 including a reflection mirror 107, photographing lenses 231 and 232, and a CCD block 234 as shown in FIG. 25. The imaging unit 3 is rotatably supported with being inserted in a cylindrical frame 222 in the left part of the camera body 2 in the figure. The photographing direction is changed over horizontally by a driving force of the motor 211 through a gear 212 with fixing the camera body 2 in the present embodiment. The frame 222 is furnished on an inside surface 222a thereof with an unshown rotary contact via which a signal from the CCD block 234 of the imaging unit 3 is transmitted to a CPU 213. Due to the above-described structure, an image which has been read out by a CCD 233, does not require to be rectified in response to the positional relationship between the reflection mirror 107 and the CCD 233.

In both of these seventh and eighth embodiments, rotating the projected reflection mirror 107 around an optical axis of an optical system, the photographing direction can be changed over right and left with respect to an object in front of the electronic camera with fixing the camera body 2 in the photographing state. Further, since the reflection mirror 107 is structured so as to be projectable from the camera body 2, the reflection mirror 107 can be folded in the non-photographing state, and be rotated in the outside of the camera body 2 in the photographing state. Moreover, the camera body 2 is thinnest in the back-and-forth direction, so that the photographer can easily hold the camera as in the case of a silver halide photography camera. Besides, the flat camera body 2 structured like this can have a liquid crystal finder 11 on the back surface thereof, which makes it possible for the photographer to see the uprighted liquid crystal finder 11.

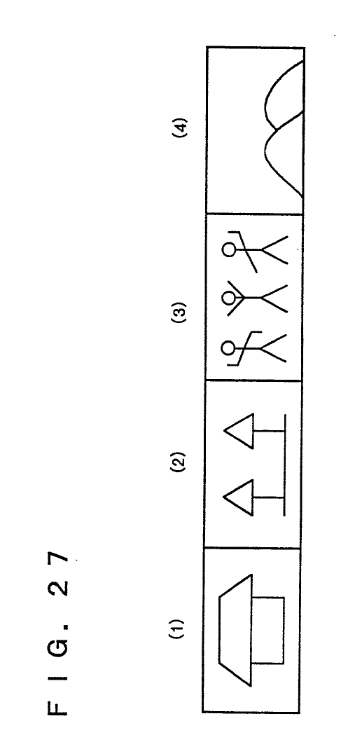

Now, the area-panorama photographing mode in the electronic camera of the above-described seventh and eighth embodiments is explained referring to FIGS. 26 and 27. FIG. 26 is an explanatory view showing the area-panorama photographing, and FIG. 27 is an explanatory view showing an image which is picked up by the area-panorama photographing shown in FIG. 26. When the shutter release button 5 is pushed in a state that the selector switch 204 is set on the area-panorama photography mode, an area (1) shown in FIG. 26 which is the two-dimensional image in response to a position of the reflection mirror 107, is photographed first of all. Following it, every time the reflection mirror 107, being driven by the motor 211, turns 90 degrees counterclockwise, a two-dimensional image in each of areas (2)-(4) is photographed in response to the position of the reflection mirror 107. Based on the two-dimensional image for each of the areas (1)-(4), a surrounding panorama image is achieved as shown in FIG. 27.

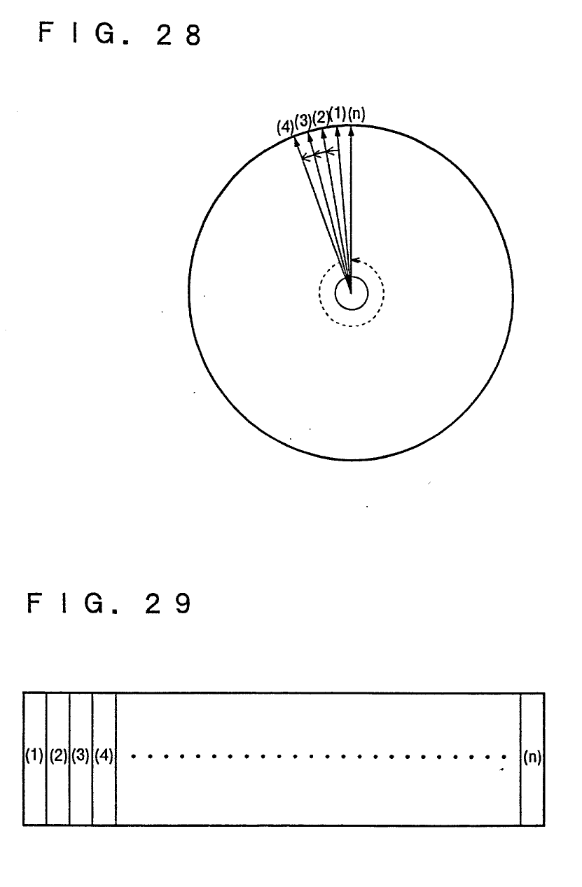

Secondly, the line-panorama photographing in the electronic camera of the above-described seventh and eighth embodiment is explained referring to FIGS. 28 and 29. FIG. 28 is an explanatory view showing the line-panorama photographing, and FIG. 29 is an explanatory view showing an image which is picked up by the line-panorama photographing shown in FIG. 28. When the shutter release button 5 is pushed in a state that the selector switch 204 is set on the line-panorama photography mode, an line (1) shown in FIG. 28 which is the one-dimensional image (line-by-line image picked up by the CCD 233) in response to a position of the reflection mirror 107, is photographed first of all. Following it, every time the reflection mirror 107, being driven by the motor 211, turns a predetermined degree counterclockwise, a CCD 233 photographs a one-dimensional image on each of lines (2)-(n) in response to the position of the reflection mirror 107. The two-dimensional image for a sequence of lines (1)-(n) is achieved in the panorama image by the CPU 213 as shown in FIG. 29. The photographing range to be picked up by the CCD 233 can be arbitrarily set, so that it is possible to photograph a partial panorama image, or a sequential surrounding panorama image.

In the electronic camera 1 in the above-described seventh and eighth embodiments, the photographing direction is changed over by the motor 211 driving the mirror holder 208 or the imaging unit 3 to rotate. However, it is also possible to compose a structure in which the photographing direction is changed manually.

Although the invention has been described in its preferred form with a certain degree of particularly, it is understood that the present disclosure of the preferred form has been changed in the details of construction and the combination and arrangement of parts may be resorted to without departing from the spirit and the scope of the invention as hereinafter claimed.

What is claimed is:

1. An electronic camera comprising:
an imaging unit which includes a photographic optical system for projecting an image of an object to be photographed, and an imaging device for converting the image projected by the photographic optical system into an electrical signal; and,
a camera body which rotatably holds the imaging unit,
wherein the camera body is thinnest in a back-and-forth direction; and,
wherein an imaging unit has a rotational shaft vertical to an optical axis of the photographic optical system, and rotates in a horizontal direction, and the photographing direction is changeable in both directions of right and left.

2. An electronic camera comprising:
an imaging unit which includes a photographic optical system for projecting an image of an object to be photographed, and an imaging device for converting the image projected by the photographic optical system into an electrical signal; and,
a camera body which rotatably holds the imaging unit,
wherein the camera body is thinnest in a back-and-forth direction;
wherein the photographic optical system and the imaging device are arranged in a nearly vertical direction; and,
wherein the photographic optical system is equipped in an object side thereof with a reflection mirror which deflects a light flux into the photographic optical system and is folded when the camera is not in use.

3. An electronic camera as claimed in claim 2, wherein the imaging device is composed of a charge-coupled device.

4. An electronic camera as claimed in claim 2, wherein the reflection mirror is folded so as to hide the photographic optical system.

5. An electronic camera comprising:
an imaging unit which includes a photographic optical system for projecting an image of an object to be photographed, and an imaging device for converting the image projected by the photographic optical system into an electrical signal; and,
a camera body which rotatably holds the imaging unit,
wherein the photographic optical system and the imaging device are arranged in a nearly vertical direction; and,
wherein the photographic optical system has in an object side thereof a reflection mirror which deflects a light flux into the photographic optical system, and is popped up from the camera body and rotatable around an optical axis, so that all the objects around the camera are capable of being photographed by rotating the reflection mirror.

6. An electronic camera as claimed in claim 5, wherein the camera body is thinnest in a back-and-forth direction thereof.

7. An electronic camera as claimed in claim 5 further comprising a driver which drives the reflection mirror to rotate, wherein the imaging device executes a photography at every predetermined interval in connection with the rotation of the reflection mirror.

8. An electronic camera as claimed in claim 7, wherein the imaging device photographs a plurality of two-dimensional images.

9. An electronic camera as claimed in claim 7, wherein the imaging device sequentially photographs one-dimensional images.
